(19) United States
(12) Patent Application Publication
(10) Pub. No.: US 2012/0114020 A1
(43) Pub. Date: May 10, 2012

(54) DE-SPREADING METHOD FOR NONCOHERENT RECEIVER AND RECEIVER APPLYING THE SAME

(76) Inventors: Wei-Tun Peng, Hsinchu City (TW); Chun-Chin Chen, Taoyuan City (TW)

(21) Appl. No.: 12/941,574

(22) Filed: Nov. 8, 2010

(51) Int. Cl. H04B 1/707

(52) U.S. Cl. 375/152; 375/E01.018

(57) ABSTRACT

The present invention is directed to a de-spreading method for a noncoherent receiver including: obtaining an output signal from a matched filter of a noncoherent receiver, which is PSK modulated and is at least two times upsampled; performing a noncoherent demodulation step including performing a differential operation on an in-phase and quadrature-phase components of the output signal of the matched filter to obtain a demodulated signal; and performing a de-spreading step on the demodulated signal with a PN table corresponding to the demodulated signal to obtain the de-spreaded data, wherein the PN table corresponding to the demodulated data contains chips which are either logic 1 or logic −1. A noncoherent receiver is also provided.

### BACKGROUND OF THE INVENTION

1. Field of the Invention

The present invention relates to a de-spreading method for receiver and the receiver applying the same in a spread spectrum communication system, and more particularly to a de-spreading method for a noncoherent receiver and the noncoherent receiver applying the same.

2. Description of the Prior Art

A spread spectrum communication system enables the transmission bandwidth of a transmitted signal to be much larger than a required bandwidth for transmitting information data carried by the transmitted signal. Such system has the following advantages: through a spreading process on a transmitter end and a de-spreading process on a receiver end, the transmitted information data acquires a spreading gain, and becomes less susceptible to noise and interference; the system is less affected by multi-path fading, and is inherently more secure.

One of the spreading methods is DS-SS (direct sequence spread spectrum). Its applications include GPS, DS-CDMA, the IEEE 802.11b 2.4 GHz WiFi standard and the IEEE 802.15.4 standard. Table 1 is a symbol-to-chip mapping PN table. DS-SS uses the PN table to map each symbol in the information data to its corresponding PN code. For example, DS-SS may treat 4 bits of the information data as a symbol which therefore ranges from 0 to 15, and then maps each symbol to a PN code according to table 1.

TABLE 1

| Symbol | PN code |
|---|---|
| 0 | 0 0 0 0 0 0 1 1 0 1 1 0 1 1 1 1 |
| 1 | 1 1 0 0 0 0 0 0 1 1 0 1 1 0 1 1 |
| 2 | 1 1 1 1 0 0 0 0 0 0 1 1 0 1 1 0 |
| 3 | 1 0 1 1 1 1 0 0 0 0 0 0 1 1 0 1 |
| 4 | 0 1 1 0 1 1 1 1 0 0 0 0 0 0 1 1 |
| 5 | 1 1 0 1 1 0 1 1 1 1 0 0 0 0 0 0 |
| 6 | 0 0 1 1 0 1 1 0 1 1 1 1 0 0 0 0 |
| 7 | 0 0 0 0 1 1 0 1 1 0 1 1 1 1 0 0 |
| 8 | 0 1 0 1 0 1 1 0 0 0 1 1 1 0 1 0 |
| 9 | 1 0 0 1 0 1 0 1 1 0 0 0 1 1 1 0 |
| 10 | 1 0 1 0 0 1 0 1 0 1 1 0 0 0 1 1 |
| 11 | 1 1 1 0 1 0 0 1 0 1 0 1 1 0 0 0 |
| 12 | 0 0 1 1 1 0 1 0 0 1 0 1 0 1 1 0 |
| 13 | 1 0 0 0 1 1 1 0 1 0 0 1 0 1 0 1 |
| 14 | 0 1 1 0 0 0 1 1 1 0 1 0 0 1 0 1 |
| 15 | 0 1 0 1 1 0 0 0 1 1 1 0 1 0 0 1 |

Generally speaking, the transmitter end of the DS-SS system processes the information data with a spreading method to obtain a spreaded data and then processes the spreaded data with a modulation method to generate a modulated signal to be further processed and transmitted; the receiver end of the DS-SS system receives and processes a received signal, processes the received signal with a demodulation method to obtain a demodulated signal and then processes the demodulated signal with a de-spreading method to retrieve the information data.

There exists a plenty of modulation methods which can be classified according to its demodulation method being coherent or noncoherent. Coherent demodulation requires carrier recovery and timing recovery to obtain the phase and the frequency of the carrier signal which are to be further removed to obtain a clock synchronized with that of the spreaded data on the transmitter end as the reference clock of the demodulated signal. Thus, a coherent receiver has a more complicated circuit and higher cost. Noncoherent demodulation does not need to perform carrier recovery to obtain the clock synchronized with the spreaded data on the transmitter end and therefore has a simpler circuit and lower cost for its receiver.

One of the modulation methods is PSK (phase-shift keying), and the corresponding noncoherent demodulation method is differential demodulation. Simply speaking, differential demodulation uses a delayed sample r(k−D) of the received signal as a reference of a current sample r(k) of the received signal, wherein r is the received signal, k is the current time index, D is the delay in time index. Therefore, differential demodulation does not need to acquire the clock synchronized with the spreaded data of the transmitting end.

A prior art DPSK (differential phase shift keying) modulation scheme performs differential encoding on the spreaded data on the transmitter end and performs differential decoding (i.e. differential demodulation) on the received signal on the receiver end. Then the receiver performs a correlation operation on every 16 chips of the demodulated signal and the PN code of each symbol for symbol decision.

In order to lower the PER (packet error rate), a PN table such as Table 1 is designed to have good auto-correlation and cross-correlation properties. Auto-correlation property refers to the correlation result of any symbol and the symbol itself; cross-correlation property refers to the correlation result of the symbol and any other symbol in the table. FIG. 1 is a diagram illustrating the auto-correlation property and cross-correlation property of symbol 0 in table 1. As shown in FIG. 1, to achieve correct symbol decision, the absolute value of the auto-correlation property should be higher than that of the cross-correlation property, and the higher the better.

The prior art DPSK modulation scheme requires the spreaded data to be encoded first on the transmitter end for differential decoding to be performed on the receiver end. It would be more efficient if the spreaded data does not need to undergo differential encoding. However, that means the PN table for despreading has to be correspondingly transformed. Therefore, it is highly desirable to construct a transformed PN table that can maintain or have even better auto-correlation and cross-correlation properties.

### SUMMARY OF THE INVENTION

The present invention is directed to a de-spreading method for a noncoherent receiver and the noncoherent receiver applying the same performing a noncoherent demodulation step on an output signal from a matched filter to obtain a demodulated signal, and performing a de-spreading step on the demodulated signal with a corresponding PN table. Since the auto-correlation and cross-correlation properties of the PN table are better, the PER (packet error rate) may be reduced, or the SNR (signal-to-noise ratio) requirement may be lowered.

According to an embodiment, the de-spreading method for the non-coherent receiver includes inputting a digital baseband signal to a matched filter to obtain an output signal from the matched filter, and making the output signal from the matched filter to be at least two times upsampled; performing a noncoherent demodulation step on the output signal from the matched filter to obtain a demodulated signal; and using a PN table corresponding to the demodulated signal to perform a de-spreading step on the demodulated signal, wherein each chip of the PN table is logic 1 or logic −1. The noncoherent demodulation step includes performing a differential operation on the output signal of the matched filter and may further includes quantizing the output signal of the matched filter before the differential operation or quantizing the demodulated signal after the differential operation.

According to an embodiment, the noncoherent receiver includes a matched filter, a noncoherent demodulator and a de-spreader. The matched filter receives a digital baseband signal, and outputs an output signal which is at least two times upsampled. The noncoherent demodulator receives the output signal from the matched filter and performs a noncoherent demodulation step on the output signal from the matched filter to output a demodulated signal. The de-spreader receives the demodulated signal and a PN table corresponding to the demodulated signal to perform a de-spreading step on the demodulated signal, wherein each chip of the PN table is logic 1 or logic −1.

The objective, technologies, features and advantages of the present invention will become more apparent from the following description in conjunction with the accompanying drawings, wherein certain embodiments of the present invention are set forth by way of illustration and examples.

### BRIEF DESCRIPTION OF THE DRAWINGS

FIG. 1 is a diagram illustrating the auto-correlation property and cross-correlation property of symbol 0 in table 1

FIG. 2 is a flow chart illustrating a de-spreading method for a noncoherent receiver according to an embodiment of the present invention;

FIG. 3 is a block diagram illustrating the noncoherent receiver according to an embodiment of the present invention;

FIG. 4 is a schematic diagram illustrating a spread spectrum system with the noncoherent receiver applying the de-spreading method;

FIG. 5 is a block diagram illustrating a noncoherent receiver according to an embodiment of the present invention;

FIG. 6 is a flow chart illustrating the method for generating the PN table corresponding to the demodulated signal;

FIG. 7 is a block diagram schematically illustrating the system for generating the PN table considering the matched filter response;

FIG. 8 is a time domain diagram of the differentially transformed signal of symbol 0;

FIG. 9a shows the auto-correlation and cross-correlation properties of the symbol 0 of the PN table (Table 2) only undergoing differential transformation; and

FIG. 9b shows the auto-correlation and cross-correlation properties of the symbol 0 of the PN table (Table 3) considering the matched filter response.

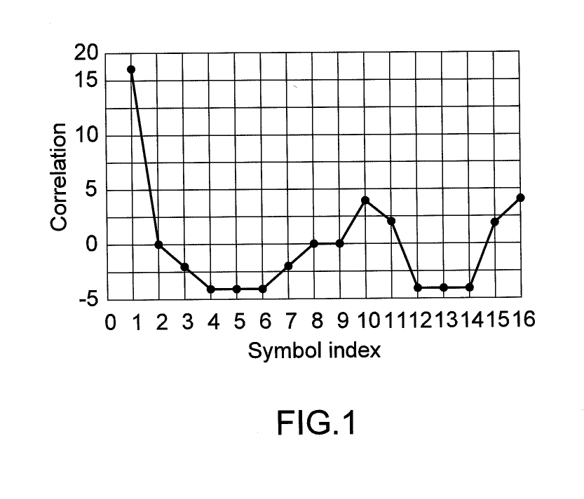

### DESCRIPTION OF THE PREFERRED EMBODIMENT

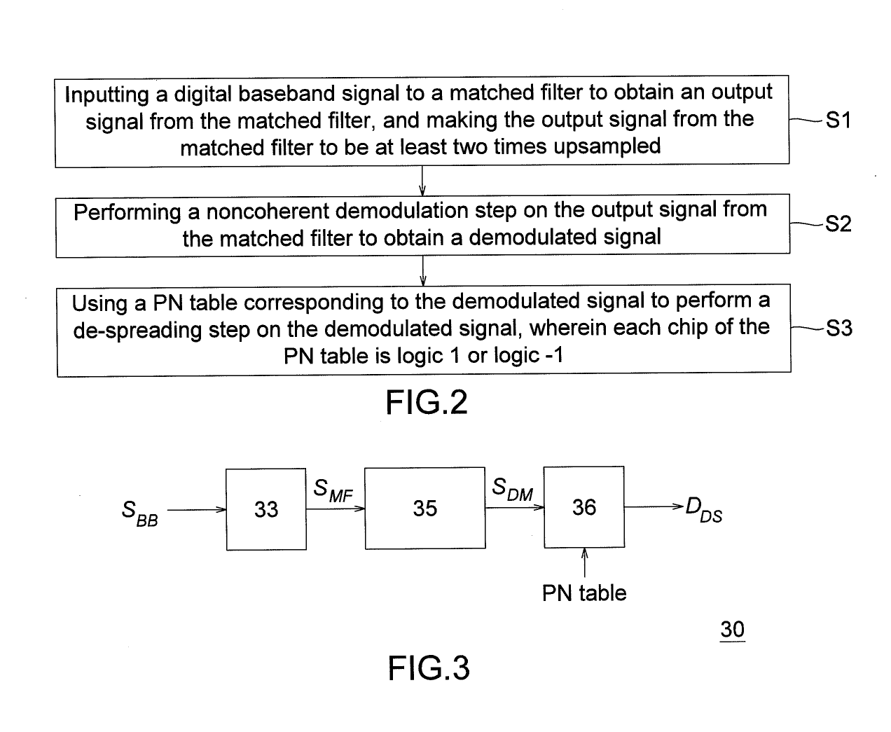

FIG. 2 is a flow chart illustrating a de-spreading method for a noncoherent receiver according to an embodiment. Referring to FIG. 2, the de-spreading method for a noncoherent receiver includes: (S1) inputting a digital baseband signal to a matched filter to obtain an output signal from the matched filter, and making the output signal from the matched filter to be at least two times upsampled; (S2) performing a noncoherent demodulation step on the output signal from the matched filter to obtain a demodulated signal; and (S3) using a PN table corresponding to the demodulated signal to perform a de-spreading step on the demodulated signal, wherein each chip of the PN table is logic 1 or logic −1.

In order to implement the de-spreading method for the noncoherent receiver, the present invention also provides a noncoherent receiver. FIG. 3 is a block diagram illustrating the noncoherent receiver according to an embodiment. Deferring to FIG. 3, the noncoherent receiver 30 includes a matched filter 33 receiving a digital baseband signal S_{BB}, and outputting an output signal S_{MF} which is at least two times upsampled; a noncoherent demodulator 35 receiving the output signal S_{MF} from the matched filter 33 and performing a noncoherent demodulation step on the output signal S_{MF} from the matched filter 33 to output a demodulated signal S_{DM}; and a de-spreader 36 receiving the demodulated signal S_{DM} and a PN table corresponding to the demodulated signal S_{DM} to perform a de-spreading step on the demodulated signal S_{DM}, wherein each chip of the PN table is logic 1 or logic −1.

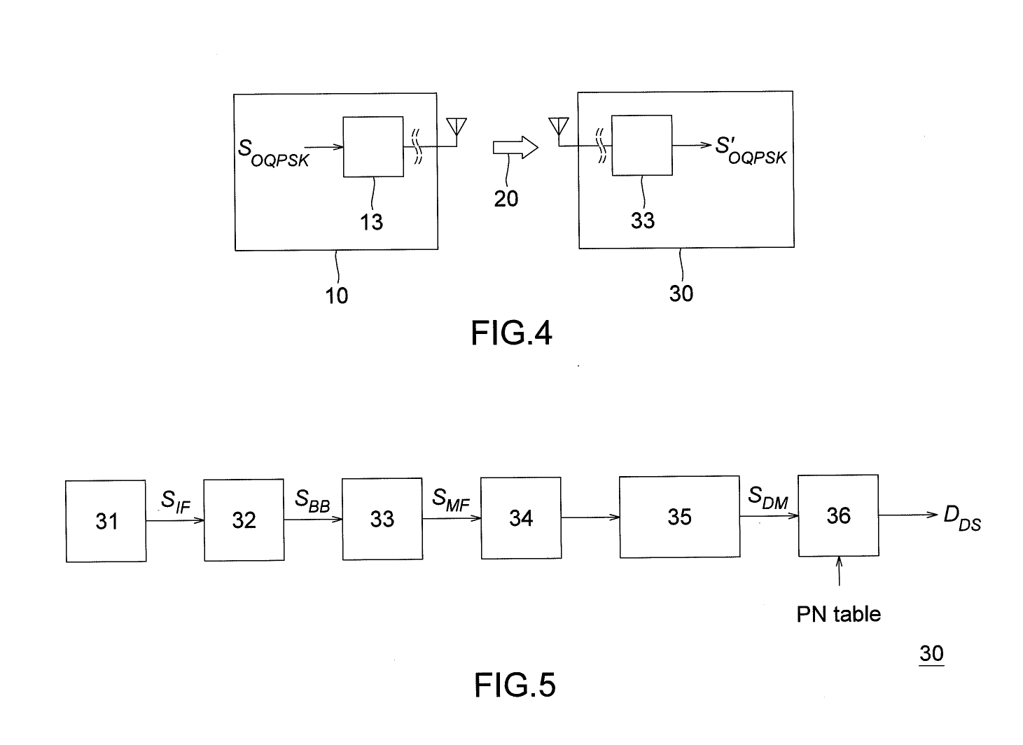

The foregoing de-spreading method for noncoherent receiver and the noncoherent receiver are applied in a spread spectrum system. FIG. 4 is a schematic diagram illustrating a spread spectrum system with the noncoherent receiver applying the de-spreading method. Referring to FIG. 4, the spread spectrum system includes a transmitter 10, the aforementioned noncoherent receiver 30 and at least one communication channel 20 exists therebetween. The transmitter 10 adopts DS-SS (direct sequence spread spectrum) and PSK (phase-shift keying); the noncoherent receiver 30 adopts differential demodulation. PSK includes BPSK (binary phase shift keying), QPSK, (quadrature phase shift keying), OQPSK (offset quadrature phase shift keying),

$$\frac{π}{4} QPSK ( \frac{π}{4} quadrature phase shift keying ) ,$$

MPSK (M-ary phase shift keying) and so on. Among them, OQPSK works the best for differential demodulation.

Referring to FIG. 4, when the OQPSK signal output from the transmitter 10 is a square wave, it is easier to cause interchip interference (ICI). Ideally, to reduce ICI, the OQPSK signal would undergo Nyquist filtering. In practice, the OQPSK signal S_{OQPSK} would first be filtered by a pulse shaping filter 13 and then transmitted by the transmitter 10. Since different communication channels 20 has different channel effects, a matched filter 30 is arranged on the noncoherent receiver so that the overall frequency response of the pulse shaping filter 13, the channel 20 and the matched filter is close to the Nyquist filter response. For example, IEEE 802.15.4 has the OQPSK signal S_{OQPSK} filtered with a half sine pulse shaping filter 13, and acquires a result equivalent to MSK (minimum shift keying). Then the pulse shaped OQPSK signal S_{OQPSK} is transmitted through the channel 20 and then reaches the matched filter 33. In the ideal situation, the output signal S_{MF} (shown in FIG. 3) of the matched filter 33 can be considered as the Nyquist filter response S′_{OQPSK} of the OQPSK signal.

The aforementioned pulse shaping filter 13 of the transmitter 10, and the matched filter 33 of the noncoherent receiver both perform digital signal processing. Therefore, the transmitter 10 also has to perform digital to analog conversion on the output signal of the pulse shaping filter 13 and transmits the signal at radio frequency; the receiver 30 has to perform analog to digital conversion on the receiving RF (radio frequency) signal, and down converts the frequency to base band.

FIG. 5 is a block diagram illustrating a noncoherent receiver according to an embodiment. Referring to FIG. 5, the noncoherent receiver further includes a ADC (analog to digital converter) 31, a down converter 32 connected between the ADC and the matched filter 33, a down sampler 34 connected between the matched filter 33 and the noncoherent demodulator 35. The RF signal (not shown) received by the noncoherent receiver 30 is down converted to an IF (intermediate frequency) signal (not shown), converted by the ADC 31 to a digital IF signal S_{IF}, and down converted by the down converter 32 to a digital base band signal S_{BB}. Also, in order to use digital filters such as the matched filter 33, the digital base band signal S_{BB} is oversampled, i.e. the sampling frequency of the digital base band signal S_{BB} is larger than 2 times the maximum frequency of its corresponding analog base band signal.

Continuing the above description, the digital base band signal S_{BB} here is the digital base band signal S_{BB} in step S1 and FIG. 3. Because the digital base band signal S_{BB} is oversampled, the output signal S_{MF} of the matched filter 33 is also oversampled. In the present embodiment, the output signal S_{MF} of the matched filter 33 is down sampled by the down sampler 34 so that the output signal S_{MF} of the matched filter 33 to be input to the noncoherent demodulator 35 is at least two times upsampled. For example, suppose the oversampling factor of the digital base band signal S_{BB} is 8, that means the oversampling factor of the output signal S_{MF} of the matched filter 33 is also 8. After being down sampled by a factor of 4 by the down sampler 34, the output signal S_{MF} of the matched filter 33 has an upsampling factor of 2 and is input to the noncoherent demodulator 35. It should be comprehensible that the above-mentioned method is only one of the many ways to make the upsampling factor of the output signal S_{MF} of the matched filter 33 to be 2.

Next, referring to FIG. 5, the noncoherent demodulator 35 performs a noncoherent demodulation step on the output signal S_{MF} of the matched filter 33 (i.e. step S2). Since the output signal S_{MF} of the matched filter 33 is an OQPSK modulated signal, it contains an in-phase component I and a quadrature-phase component Q. According to an embodiment, the noncoherent demodulation step includes performing a differential operation on the output signal S_{MF} of the matched filter 33 to obtain a demodulated signal S_{DM}, as shown by equation (1):

S_{DM}(k)=I(k−1)Q(k)−I(k)Q(k−1) (1)

where k is the time index. Because of hardware constraints, in one embodiment, the output signal S_{MF} of the matched filter 33 may be quantized before the differential operation; or the demodulated signal S_{DM} after the differential operation may be quantized.

Next, referring to FIG. 5, the de-spreader 36 performs a de-spreading step on the demodulated signal S_{DM} with the PN table corresponding to the demodulated signal S_{DM} to obtain a de-spreaded data. In the present embodiment, since the output signal S_{MF} of the matched filter 33 is transformed with the differential operation to achieve noncoherent demodulation, the original PN table used during spreading on the transmitter 10 (such as Table 1) also needs to be transformed with differential operation before it can be used for de-spreading.

According to an embodiment, before the original PN table is being transformed, its PN codes need to be preprocessed. First, the PN codes consisted of {0, 1} are converted to {−1, 1}. Then chips of each PN code is divided into odd and even group respectively corresponding to the in-phase component I and quadrature-phase component Q. For OQPSK, since there exists a delay between the in-phase component I and the quadrature-phase component Q, 0 is inserted before each chip of the in-phase component I, and after each chip of the quadrature-phase component Q. Then the differential operation may be performed on the in-phase component I and the quadrature-phase component Q of each PN code. Table 2 shows the differentially transformed PN table.

TABLE 2

| Symbol | PN code |
|---|---|
| 0 | 1 1 −1 1 −1 1 1 1 1 −1 −1 −1 1 1 −1 1 |
| 1 | −1 1 1 1 −1 1 −1 1 1 1 1 −1 −1 −1 1 1 |
| 2 | 1 1 −1 1 1 1 −1 1 −1 1 1 1 1 −1 −1 −1 |
| 3 | −1 −1 1 1 −1 1 1 1 −1 1 −1 1 1 1 1 −1 |
| 4 | 1 −1 −1 −1 1 1 −1 1 1 1 −1 1 −1 1 1 1 |
| 5 | 1 1 1 −1 −1 −1 1 1 −1 1 1 1 −1 1 −1 1 |
| 6 | −1 1 1 1 1 −1 −1 −1 1 1 −1 1 1 1 −1 1 |
| 7 | −1 1 −1 1 1 1 1 −1 −1 −1 1 1 −1 1 1 1 |
| 8 | −1 −1 1 −1 1 −1 −1 −1 −1 1 1 1 −1 −1 1 −1 |
| 9 | 1 −1 −1 −1 1 −1 1 −1 −1 −1 −1 1 1 1 −1 −1 |
| 10 | −1 −1 1 −1 −1 −1 1 −1 1 −1 −1 −1 −1 1 1 1 |
| 11 | 1 1 −1 −1 1 −1 −1 −1 1 −1 1 −1 −1 −1 −1 1 |
| 12 | −1 1 1 1 −1 −1 1 −1 −1 −1 1 −1 1 −1 −1 −1 |
| 13 | −1 −1 −1 1 1 1 −1 −1 1 −1 −1 −1 1 −1 1 −1 |
| 14 | 1 −1 −1 −1 −1 1 1 1 −1 −1 1 −1 −1 −1 1 −1 |
| 15 | 1 −1 1 −1 −1 −1 −1 1 1 1 −1 −1 1 −1 −1 −1 |

As mentioned above, to lower PER (packet error rate), a PN table should have good auto-correlation and cross-correlation properties. Taking symbol 0 in Table 2 for example, its auto-correlation property is calculated by performing correlation operation on PN₀ (PN code of symbol 0) itself, and its cross-correlation property with symbol 1 is calculated by performing correlation operation on PN₀ and PN₁, as shown in equation (2):

$$cor ( x , y ) = {\sum }_{i = 1}^{N} x ( i ) \cdot y ( i ) \qquad ( 2 )$$

wherein i is the chip index, N is the number of chips, x=y=PN₀ for PN₀ auto-correlation, and x=PN₀, y=PN₁ for PN₀ and PN₁ cross-correlation.

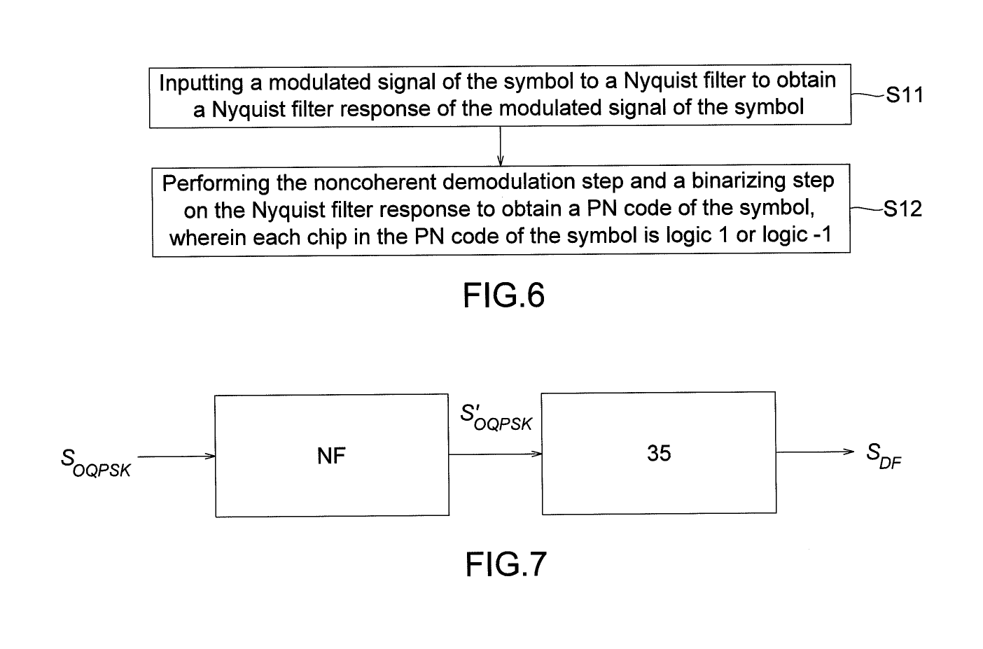

In the present embodiment, referring to FIG. 4 and FIG. 5, in order to enhance the auto-correlation and cross-correlation properties of Table 2, the PN table corresponding to the demodulated signal S_{DM} is constructed by taking the effect that the output signal S_{MF} of the matched filter 33 is close to the Nyquist filter response of a OQPSK signal S_{OQPSK} into consideration. FIG. 6 is a flow chart illustrating the method for generating the PN table corresponding to the demodulated signal. Referring to FIG. 6, the method for generating a PN code for any symbol of the PN table includes: (S11) inputting a modulated signal of the symbol to a Nyquist filter to obtain a Nyquist filter response of the modulated signal of the symbol; performing the noncoherent demodulation step and a binarizing step on the Nyquist filter response to obtain a PN code of the symbol, wherein each chip in the PN code of the symbol is logic 1 or logic −1.

FIG. 7 is a block diagram schematically illustrating the system for generating the PN table considering the matched filter response. Referring to FIG. 7, the OQPSK modulated signal S_{OQPSK} is first obtained for PN₀ of Table 1, and then input to the Nyquist filter NF to obtain a Nyquist filter response S′_{OQPSK}. The process can be represented with equation (3):

S′_{OQPSK}(t)=S_{OQPSK}(t)*h(t) (3)

wherein h(t) is the impulse response of the Nyquist filter NF, * denotes the convolution operation, and t represents time. For simplification purpose, the equation is represented in terms of continuous time t, but in reality, the OQPSK signal S_{OQPSK}, the impulse response h of Nyquist filter NF, and the Nyquist filter response S′_{OQPSK} are discrete. It has to be clarified that the Nyquist filter NF is an ideal filter and in practice, only similar effects can be achieved. However, the term Nyquist filter is used herein to represent all the filters having similar properties. According to an embodiment, the Nyquist filter NF is a raised cosine filter, of which impulse response is represented by equation (4):

$$h ( t ) = \{ \begin{matrix}\frac{sin ( π t / {T}_{c} )}{π t / {T}_{c}} \cdot \frac{cos ( r π t / {T}_{c} )}{1 - 4 {r}^{2} {t}^{2} / {T}_{c}} , & t = 0 \\ 1 , & t \neq 0\end{matrix} \qquad ( 4 )$$

where r is a roll off factor, T_{c} is a chip period of the OQPSK signal S_{OQPSK}.

Next, as mentioned in step 12, the Nyquist filter response S′_{OQPSK} undergoes the noncoherent demodulation step and the binarizing step. Before the noncoherent demodulation step is performed, the upsampling factor of the Nyquist filter response S′_{OQPSK} should be made at least 2. Here the case where the upsampling factor is 2 is taken as an example below. After the differential operation as shown in equation (1) is performed on the Nyquist filter response S′_{OQPSK}, a differentially transformed signal S_{DF} which has a sampling frequency twice as much as the chip rate of the OQPSK signal S_{OQPSK} is obtained. Therefore, although the original PN table (table 1) has 16-chip PN code, the PN table considering the matched filter response has 32-chip PN code.

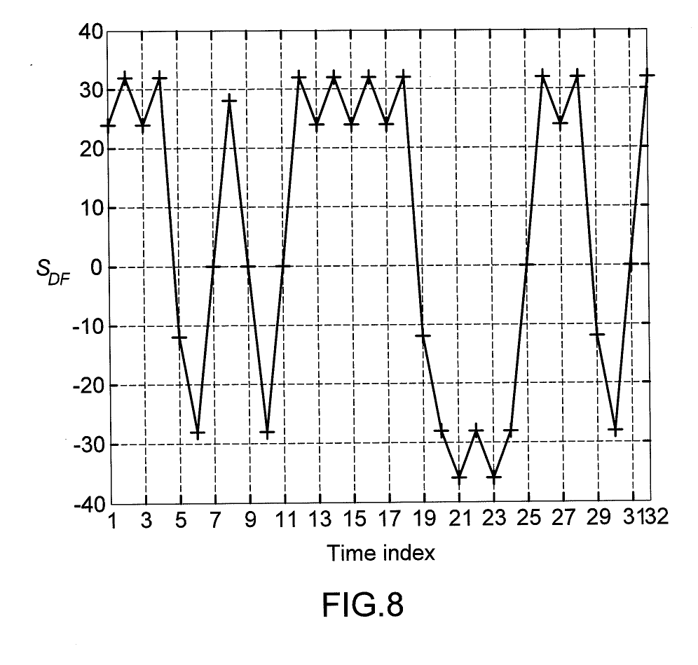

FIG. 8 is a time domain diagram of the differentially transformed signal of symbol 0, where the horizontal axis is the time index, and the vertical axis is the amplitude of the differentially transformed signal S_{DF}. As shown in FIG. 8, the differentially transformed signal S_{DF} is a floating point number and in an embodiment, the amplitude of the differentially transformed signal S_{DF} is first normalized to be with in the range of −1˜1. Next, the normalized amplitude of the differentially transformed signal S_{D} is mapped to 1 or −1 according to a specific rule, so as to obtain the PN code of the symbol 0. For example, the specific rule may involve: when the sample is greater than 0, mapping it to logic 1; when the sample S_{DM}(k) is less than 0, mapping it to logic −1; and when the sample S_{DM}(k) is equal to 0, depending on the samples {S_{DM}(k−1), S_{DM}(k+1)} are respectively mapped to logic 1 and logic −1, or logic −1 and logic 1, mapping the sample S_{DM}(k) to logic −1 or logic 1, where k is the current time index. Following the same manner to obtain the PN codes of other symbols, a PN table (as shown in Table 3) considering the matched filter response and corresponding to the demodulated signal is obtained, as the one mentioned in step S3.

TABLE 3

| Symbol | PN code |
|---|---|
| 0 | 1 1 1 1 −1 −1 1 1 −1 −1 1 1 1 1 1 1 1 1 −1 −1 −1 −1 −1 −1 1 1 1 1 −1 −1 1 1 |
| 1 | −1 −1 1 1 1 1 1 1 −1 −1 1 1 −1 −1 1 1 1 1 1 1 1 1 −1 −1 −1 −1 −1 −1 1 1 1 1 |
| 2 | 1 1 1 1 −1 −1 1 1 1 1 1 1 −1 −1 1 1 −1 −1 1 1 1 1 1 1 1 1 −1 −1 −1 −1 −1 −1 |
| 3 | −1 −1 −1 −1 1 1 1 1 −1 −1 1 1 1 1 1 1 −1 −1 1 1 −1 −1 1 1 1 1 1 1 1 1 −1 −1 |
| 4 | 1 1 −1 −1 −1 −1 −1 −1 1 1 1 1 −1 −1 1 1 1 1 1 1 −1 −1 1 1 −1 −1 1 1 1 1 1 1 |
| 5 | 1 1 1 1 1 1 −1 −1 −1 −1 −1 −1 1 1 1 1 −1 −1 1 1 1 1 1 1 −1 −1 1 1 −1 −1 1 1 |
| 6 | −1 −1 1 1 1 1 1 1 1 1 −1 −1 −1 −1 −1 −1 1 1 1 1 −1 −1 1 1 1 1 1 1 −1 −1 1 1 |
| 7 | −1 −1 1 1 −1 −1 1 1 1 1 1 1 1 1 −1 −1 −1 −1 −1 −1 1 1 1 1 −1 −1 1 1 1 1 1 1 |
| 8 | −1 −1 −1 −1 1 1 −1 −1 1 1 −1 −1 −1 −1 −1 −1 −1 −1 1 1 1 1 1 1 −1 −1 −1 −1 1 1 −1 −1 |
| 9 | 1 1 −1 −1 −1 −1 −1 −1 1 1 −1 −1 1 1 −1 −1 −1 −1 −1 −1 −1 −1 1 1 1 1 1 1 −1 −1 −1 −1 |
| 10 | −1 −1 −1 −1 1 1 −1 −1 −1 −1 −1 −1 1 1 −1 −1 1 1 −1 −1 −1 −1 −1 −1 −1 −1 1 1 1 1 1 1 |
| 11 | 1 1 1 1 −1 −1 −1 −1 1 1 −1 −1 −1 −1 −1 −1 1 1 −1 −1 1 1 −1 −1 −1 −1 −1 −1 −1 −1 1 1 |
| 12 | −1 −1 1 1 1 1 1 1 −1 −1 −1 −1 1 1 −1 −1 −1 −1 −1 −1 1 1 −1 −1 1 1 −1 −1 −1 −1 −1 −1 |
| 13 | −1 −1 −1 −1 −1 −1 1 1 1 1 1 1 −1 −1 −1 −1 1 1 −1 −1 −1 −1 −1 −1 1 1 −1 −1 1 1 −1 −1 |
| 14 | 1 1 −1 −1 −1 −1 −1 −1 −1 −1 1 1 1 1 1 1 −1 −1 −1 −1 1 1 −1 −1 −1 −1 −1 −1 1 1 −1 −1 |
| 15 | 1 1 −1 −1 1 1 −1 −1 −1 −1 −1 −1 −1 −1 1 1 1 1 1 1 −1 −1 −1 −1 1 1 −1 −1 −1 −1 −1 −1 |

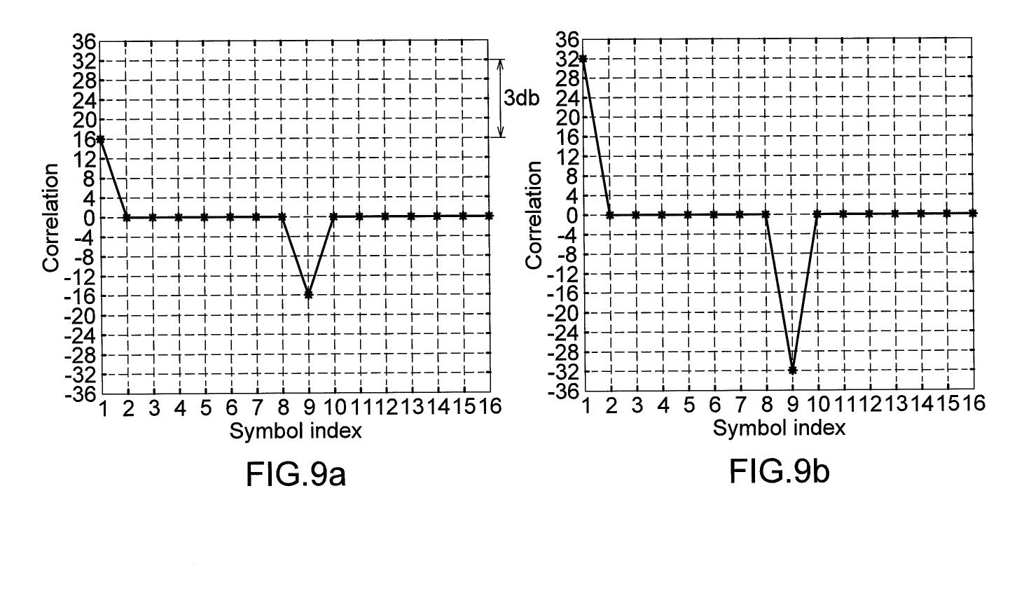

FIG. 9a shows the auto-correlation and cross-correlation properties of the symbol 0 of the PN table (Table 2) only undergoing differential transformation; FIG. 9b shows the auto-correlation and cross-correlation properties of the symbol 0 of the PN table (Table 3) considering the matched filter response. Comparing FIG. 9a and FIG. 9b, the auto-correlation property of PN₀ of the PN table (Table 3) considering the matched filter response has a 3 dB gain over that of the PN table (Table 2) only undergoing differential transformation. Therefore, the PN table (Table 3) considering the matched filter response compared to the PN table (Table 2) undergoing only differential transformation may have higher PER, or require lower SNR (signal-to-noise ratio) for the same PER.

Referring to FIG. 5, the above-mentioned de-spreading step includes performing a correlation operation on the demodulated signal S_{DM} and each symbol of the corresponding PN table (Table 3), i.e. applying the demodulated signal S_{DM} and PN_{SB} to equation (2), wherein x=S_{DM}, y=PN_{SB}, and SB=0˜15. Next, based on the result of correlation operation cor(S_{DM},PN_{SB}), the symbol that the demodulated signal S_{DM} corresponds to can be determined, whereby the de-spreaded data D_{DS} is obtained.

Since the de-spreader 36 in FIG. 5 is required to perform the correlation operation on each symbol of Table 3, the number of correlators actually required is 16. According to an embodiment, by generating a correlation code from one of the symbols of the Table 3, the demodulated signal S_{DM} only needs to undergo a single operation as shown in equation (6) before symbol decision.

$${C}_{cor} ( j ) = {\sum }_{i = 1}^{N} {S}_{DM} ( i ) {a}_{64} ( i + j ) \qquad ( 6 )$$

where i is the time index, N=32 is the number of samples, a₆₄ is the correlation code, C_{cor} is the result and j is the index of C_{cor}, and it ranges from 1 to 32. To determine the symbol, the index of the maximum absolute value of the result C_{cor} is identified, and is processed with equation (7) when C_{cor}(jₘₐₓ)>0, equation (8) when C_{cor}(jₘₐₓ)<0.

$$\begin{matrix}SB = ( 9 - ⌈ \frac{{j}_{max}}{8} ⌉ ) mod 8 & ( 7 ) \\ SB = ( 9 - ⌈ \frac{{j}_{max}}{8} ⌉ ) mod 8 + 8 & ( 8 )\end{matrix}$$

where SB is the symbol, which ranges from 0˜15. In the present embodiment, the correlation code a₆₄ is generated by selecting any symbol from Table 3 such as PN₀, repeating it once and circular right shifting it by 4 chips.

In conclusion, the present invention provides a de-spreading method for a noncoherent receiver including obtaining the output signal of the matched filter, which is PSK modulated, preferably OQPSK modulated, and is at least two times upsampled; performing a noncoherent demodulation step which includes performing a differential operation on the in-phase and quadrature phase components of the output signal of the matched filter to obtain the demodulated signal; and performing a de-spreading step on the demodulated signal with the PN table corresponding to the demodulated signal. The method for generating the PN table corresponding to the demodulated signal considers the output signal of the matched filter should be close to the Nyquist filter response of the OQPSK signal from the transmitter. It takes the Nyquist filter response of the OQPSK signal of a symbol and performs the noncoherent demodulation step and the binarizing step to obtain the PN code. Since the PN table corresponding to the demodulated signal has better auto-correlation and cross-correlation properties, it has a better PER or requires lower SNR for the same PER during de-spreading.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A de-spreading method for a noncoherent receiver, comprising:
inputting a digital baseband signal to a matched filter to obtain an output signal from the matched filter, and making the output signal from the matched filter to be at least two times upsampled;
performing a noncoherent demodulation step on the output signal from the matched filter to obtain a demodulated signal; and
using a PN table corresponding to the demodulated signal to perform a de-spreading step on the demodulated signal, wherein each chip of the PN table is logic 1 or logic −1.

2. The de-spreading method for the noncoherent receiver according to claim 1, wherein the modulation method of the digital baseband signal comprises OQPSK or MSK.

3. The de-spreading method for the noncoherent receiver according to claim 2, wherein the noncoherent demodulation step comprises:
performing a differential operation on an in-phase component and a quadrature-phase component of the output signal from the matched filter to obtain the demodulated signal, wherein the differential operation is represented as:
S_{DM}(k)=I(k−1)Q(k)−I(k)Q(k−1)
where k is the time index, I is the in-phase component of the output signal from the matched filter, Q is the quadrature-phase component of the output signal from the matched filter, and S_{DM} is the demodulated signal.

4. The de-spreading method for the noncoherent receiver according to claim 3, wherein the noncoherent demodulation step further comprises quantizing the output signal from the matched filter before performing the differential operation.

5. The de-spreading method for the noncoherent receiver according to claim 3, wherein the noncoherent demodulation step further comprises quantizing the output signal from the matched filter after performing the differential operation.

6. The de-spreading method for the noncoherent receiver according to claim 1, wherein the PN code generation method of any symbol in the PN table comprises:
inputting a modulated signal of the symbol to a Nyquist filter to obtain a Nyquist filter response of the modulated signal of the symbol; and
performing the noncoherent demodulation step and a binarizing step on the Nyquist filter response to obtain a PN code of the symbol, wherein each chip in the PN code of the symbol is logic 1 or logic −1.

7. The de-spreading method for the noncoherent receiver according to claim 6, wherein the Nyquist filter is a raised cosine filter.

8. The de-spreading method for the noncoherent receiver according to claim 6, wherein the binarizing step performed on each sample comprises:
normalizing the sample, wherein the time index of the sample is referred to as a current time index; and
mapping the sample to logic 1 or logic −1 according to a specific rule.

9. The de-spreading method for the noncoherent receiver according to claim 8, wherein the specific rule involves: when the sample is greater than 0, mapping it to logic 1; when the sample is less than 0, mapping it to logic −1; and when the sample is equal to 0, depending on a previous sample at a time index previous to the current time index and a next sample at a time index next to the current time index are respectively mapped to logic 1 and logic −1, or logic −1 and logic 1, mapping the sample to logic −1 or logic 1.

10. A noncoherent receiver comprising:
a matched filter receiving a digital baseband signal, and outputting an output signal which is at least two times upsampled;
a noncoherent demodulator receiving the output signal from the matched filter and performing a noncoherent demodulation step on the output signal from the matched filter to output a demodulated signal; and
a de-spreader receiving the demodulated signal and a PN table corresponding to the demodulated signal to perform a de-spreading step on the demodulated signal, wherein each chip of the PN table is logic 1 or logic −1.

11. The noncoherent receiver according to claim 10, wherein the demodulation method of the digital baseband signal comprises OQPSK, or MSK.

12. The noncoherent receiver according to claim 11, wherein the noncoherent demodulation step comprises:
performing a differential operation on an in-phase component and a quadrature-phase component of the output signal from the matched filter to obtain the demodulated signal, wherein the differential operation is represented as:
S_{DM}(k)=I(k−1)Q(k)−I(k)Q(k−1)
where k is the time index, I is the in-phase component of the output signal from the matched filter, Q is the quadrature-phase component of the output signal from the matched filter, and S_{DM} is the demodulated signal.

13. The noncoherent receiver according to claim 12, wherein the noncoherent demodulation step further comprises quantizing the output signal from the matched filter before performing the differential operation.

14. The noncoherent receiver according to claim 12, wherein the noncoherent demodulation step further comprises quantizing the output signal from the matched filter after performing the differential operation.

15. The noncoherent receiver according to claim 10, wherein the PN code generation method of any symbol in the PN table comprises:
inputting a modulated signal of the symbol to a Nyquist filter to obtain a Nyquist filter response of the modulated signal of the symbol;
performing the noncoherent demodulation step and a binarizing step on the Nyquist filter response to obtain a PN code of the symbol, wherein each chip in the PN code of the symbol is logic 1 or logic −1.

16. The noncoherent receiver according to claim 15, wherein the Nyquist filter is a raised cosine filter.

17. The noncoherent receiver according to claim 15, wherein the binarizing step performed on each sample comprises:
normalizing the sample, wherein the time index of the sample is referred to as a current time index; and
mapping the sample to logic 1 or logic −1 according to a specific rule.

18. The noncoherent receiver according to claim 10, wherein the specific rule involves: when the sample is greater than 0, mapping it to logic 1; when the sample is less than 0, mapping it to logic −1; and when the sample is equal to 0, depending on a previous sample at a time index previous to the current time index and a next sample at a time index next to the current time index is respectively mapped to logic 1 and logic −1, or logic −1 and logic 1, mapping the sample to logic −1 or logic 1.
